(19) United States
(12) Patent Application Publication
(10) Pub. No.: US 2025/0273066 A1
(43) Pub. Date: Aug. 28, 2025

(54) MOBILE ROAD TRAFFIC INFORMATION PROVIDING APPARATUS AND SYSTEM FOR PROVIDING ROAD TRAFFIC INFORMATION TO AUTONOMOUS VEHICLES

(71) Applicant: Industry Academic Cooperation Foundation of Yeungnam University, Gyeongsan-si (KR)

(72) Inventor: Seong Jin KWON, Gyeongsan-si (KR)

(73) Assignee: Industry Academic Cooperation Foundation of Yeungnam University, Gyeongsan-si (KR)

(21) Appl. No.: 18/941,603

(22) Filed: Nov. 8, 2024

(30) Foreign Application Priority Data
Feb. 22, 2024 (KR) 10-2024-0025636

(51) Int. Cl. G08G 1/01; G08G 1/09

(52) U.S. Cl. CPC G08G 1/0116; G08G 1/0133; G08G 1/0141; G08G 1/09

(57) ABSTRACT

Provided is a mobile road traffic information providing apparatus for autonomous vehicles, which includes: a road traffic information collection unit that is movably installed on one side of a road and collects road traffic information, a communication unit that performs communication with an autonomous vehicle or a server, and a control unit that determines a road traffic condition based on information about a road on which the road traffic information providing apparatus is installed and the road traffic information, and provides the road traffic condition to the autonomous vehicle within a preset range or the server, wherein the road traffic information collection unit includes: a traffic light information collection unit that collects signal information of traffic lights within the preset range, and an unexpected situation detection unit that collects unexpected situation information on a road within the preset range. The present invention is directed to providing a road traffic information providing apparatus designed for mobile use that is installable where needed, thereby supplementing the insufficient infrastructure when commercializing autonomous vehicles.

### CROSS-REFERENCE TO RELATED APPLICATION

This application claims priority to and the benefit of Korean Patent Application No. 10-2024-0025636, filed on Feb. 22, 2024, the disclosure of which is incorporated herein by reference in its entirety.

### BACKGROUND

### 1. Field of the Invention

The present application relates to a mobile road traffic information providing apparatus and system for providing road traffic information to autonomous vehicles.

### 2. Discussion of Related Art

According to the Society of Automotive Engineers (SAE), autonomous driving technology may be divided into six levels from level 0 to level 5. While autonomous driving systems at levels 0 to 2 assist the driver, the system takes control of the driving from level 3. Levels 3 to 5 are defined as levels of autonomous vehicles.

Autonomous vehicles at level 3 are driven by an autonomous driving system (ADS) in most driving situations, and in dangerous situations or emergencies, driving control is transferred and a human (a driver) needs to drive the vehicle.

An autonomous vehicle uses various sensors attached to the vehicle to directly recognize external situations and drive, but there may be cases in which the field of vision is limited by the external environment while driving, and the driving stability of autonomous vehicles needs to be further improved so that it is possible to obtain information about road traffic through communication with external infrastructure and perform driving.

However, there is difficulty in the commercialization of autonomous vehicles due to a lack of infrastructure for transmitting road traffic information to autonomous vehicles.

### SUMMARY OF THE INVENTION

The present invention is directed to providing a road traffic information providing apparatus designed for mobile use that may be installed where needed. This may supplement insufficient infrastructure when commercializing autonomous vehicles.

The technical objectives of the present invention are not limited to the above, and may be variously expanded without departing from the technical concept and field of the present invention.

According to an aspect of the present invention, there is provided a mobile road traffic information providing apparatus for autonomous vehicles, including: a road traffic information collection unit that is movably installed on one side of a road and collects road traffic information; a communication unit that performs communication with an autonomous vehicle or a server; and a control unit that determines a road traffic condition based on information about a road on which the road traffic information providing apparatus is installed and the road traffic information, and provides the road traffic condition to the autonomous vehicle or the server within a preset range, wherein the road traffic information collection unit includes: a traffic light information collection unit that collects signal information of traffic lights within the preset range; and an unexpected situation detection unit that collects unexpected situation information on a road within the preset range.

The technical solutions of the present specification are not limited to the above, and other solutions may become apparent to those of ordinary skill in the art based on the following description and the accompanying drawings.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a schematic block diagram illustrating a configuration of a mobile road traffic information providing system according to one embodiment of the present application;

FIG. 2 is a diagram illustrating a configuration for collecting road traffic information using a mobile road traffic information providing system according to one embodiment of the present application; and

FIG. 3 is a diagram for describing a mobile road traffic information providing method according to one embodiment of the present application.

### DETAILED DESCRIPTION OF EXEMPLARY EMBODIMENTS

The above objects, features and advantages of the present invention will become more apparent from the following detailed description taken in conjunction with the accompanying drawings. The present invention may be modified in various ways and may have various embodiments. Hereinafter, specific embodiments will be illustrated in the drawings and described in detail.

In the following description, like reference numbers essentially designate like elements. In addition, elements having the same function within the scope of the same idea shown in the drawings of each embodiment will be described using the same reference numbers, and overlapping description will be omitted.

When it is determined that the detailed description of a known function or configuration related to the present invention may unnecessarily obscure the subject matter of the present invention, the detailed description thereof will be omitted. In addition, a number (e.g., “first,” “second,” etc.) used in the description of the present invention is merely an identifier for distinguishing one component from another component.

The terms “module” and “unit” for components used in the following description are given or used together in consideration of ease of writing the specification and do not have distinct meanings or roles by themselves.

In the embodiments below, the singular forms are intended to include the plural forms as well, unless the context clearly indicates otherwise.

It will be further understood that the terms “comprise,” “comprising,” “include,” and/or “including” used herein specify the presence of stated features, integers, steps, operations, elements, and/or components but do not preclude the possibility of the presence or addition of one or more other features, integers, steps, operations, elements, components, and/or groups thereof.

In the accompanying drawings, the size of each component shown in the drawings may be exaggerated or reduced for convenience of description. For example, the size and thickness of each component shown in the drawings are arbitrarily shown for convenience in description, and the present invention is not necessarily limited to those shown.

When an embodiment is otherwise implementable, specific processes may be performed in an order different from the described order. For example, two processes described in succession may be performed concurrently or in reverse order.

In the following embodiments, it should be understood that when an element is referred to as being “connected” to another element, the element may be directly connected to the other element or indirectly connected to the other element with intervening elements.

For example, when an element is referred to as being electrically connected to another element, the electrical connection may be direct or indirect with intervening elements.

Meanwhile, in this specification, the first autonomous vehicle and the second autonomous vehicle may be the same autonomous vehicle or different autonomous vehicles.

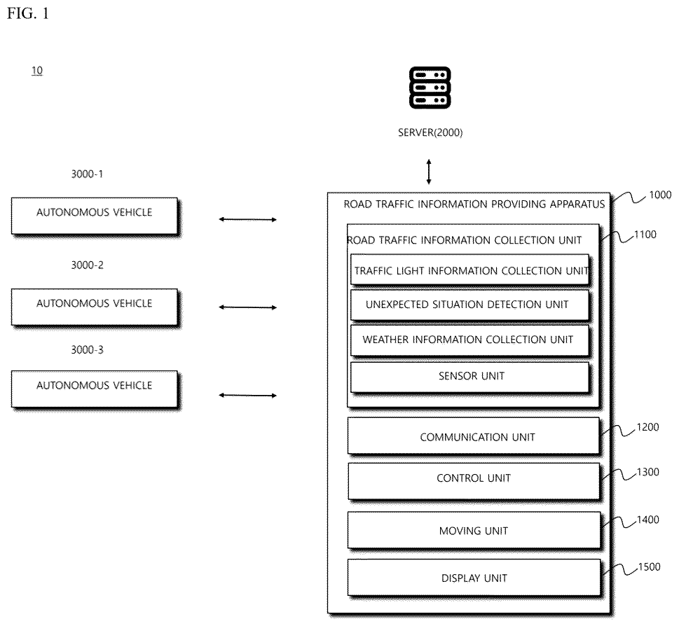

FIG. 1 is a schematic block diagram illustrating a configuration of a mobile road traffic information providing system according to one embodiment of the present application.

Referring to FIG. 1, a mobile road traffic information providing system for autonomous vehicles may include a road traffic information providing apparatus 1000, a server 2000, and a plurality of autonomous vehicles 3000-1 and 3000-2.

The road traffic information providing apparatus 1000 according to the present invention may be movably installed, may provide road traffic information to autonomous vehicles within a preset range, and may collect road traffic information from autonomous vehicles within a preset range.

The road traffic information providing apparatus 1000 may include a road traffic information collection unit 1100, a communication unit 1200, a control unit 1300, a moving unit 1400, and a display unit 1500.

The road traffic information collection unit 1100 may include a sensor unit. The road traffic information collection unit 1100 collects road traffic information within a preset range from a location in which the road traffic information providing apparatus 1000 is installed through the sensor unit, determines a traffic condition using the collected data, and transmits the determined traffic condition to a server, or an autonomous vehicle or server within the preset range through the communication unit 1200.

The sensor unit of the road traffic information collection unit 1100 may include various sensors, and may collect information related to road traffic directly from the outside or collect information related to road traffic through communication from an external server. More specifically, the sensor unit may include at least one sensor from a group including a camera, an ultrasonic sensor, the Global Positioning System (GPS), a radar, and a light detection and ranging (LiDAR).

As needed, the road traffic information providing apparatus 1000 may include a roadside base station (a road side unit: RSU), a road weather information system, and a positioning correction reference station. As needed, the road traffic information providing apparatus 1000 may receive road information from a signal controller, a crosswalk signal transmission board, a portable dangerous section notification device, safety facilities, an autonomous vehicle maintenance zone, an autonomous vehicle mobile station, a radar visual display system (a visual display system: a VDS), an LTE radio, and the like through the communication unit 1200, and through the road information, may obtain road traffic information and determine a road traffic condition.

The road traffic information collection unit 1100 may include a traffic light information collection unit, an unexpected situation detection unit, and a weather information collection unit.

The traffic light information collection unit is configured to collect signal information of a traffic light within a preset range in real time using data obtained through the sensor unit. As needed, the traffic light information collection unit may collect signals of a traffic light in real time through a camera or ultrasonic sensor of the sensor unit, or may collect signals of a traffic light within a preset range in real time through network communication. When the traffic light information collection unit collects the signal information of the traffic light through the camera or ultrasonic sensor of the sensor unit, the signal of the traffic light may be more reliably collected than using network communication, but the range of signal collection of the traffic light may be limited and may be affected by external factors, such as weather and obstacles. Therefore, by using a combination of both methods, the signal information of the traffic light may be collected more reliably.

The unexpected situation detection unit may obtain data using at least one sensor from a group including the camera, the radar, and the LiDAR of the sensor unit. The unexpected situation detection unit may obtain data of a preset area through the sensor unit and detect whether an unexpected situation occurs within the preset range. The unexpected situation detection unit may identify various unexpected situations occurring on the road using the data obtained from the sensor unit. According to a specific embodiment, the unexpected situation detection unit obtains various data on the road through the sensor unit and determines whether an unexpected situation occurs using the data. When the unexpected situation detection unit determines that an unexpected situation has occurred as a result of the determination, the unexpected situation detection unit may transmit unexpected situation information to a server, or an autonomous vehicle within the preset range.

An unexpected situation is any of various situations that may occur on the road, such as a traffic accident, a vehicle breakdown, road construction, an obstacle, road damage, and traffic congestion.

The weather information collection unit is configured to collect weather information within a preset range at a location at which the road traffic information providing apparatus 1000 is installed. As needed, the weather information collection unit may identify a location in which the road traffic information providing apparatus 1000 is installed using the GPS of the sensor unit and obtain real-time weather information of the corresponding location from the server based on information about the installation location. Alternatively, the weather information collection unit may collect weather information in real time through the camera or ultrasonic sensor of the sensor unit. When the weather information collection unit collects weather information through the camera or ultrasonic sensor, the weather information collection unit may obtain real-time weather information of the corresponding area more effectively than using network communication, but in this case, may only obtain real-time weather information and weather information may not be predicted. Therefore, by using a combination of both methods, weather information may be collected more reliably.

The communication unit 1200 may support the establishment of a direct communication channel or a wireless communication channel between the road traffic information providing apparatus 1000 and an external device, as well as communication through the established communication channel. The communication unit 1200 operates independently from the control unit 1300 and may include one or more communication processors that support direct (wired) communication or wireless communication.

The communication unit 1200 may receive driving information from an autonomous vehicle e through vehicle-to-everything (V2X) communication. Specifically, the communication unit 1200 may receive driving information including vehicle information, sensor information, emergency information, location, driving speed, and the like of the autonomous vehicle from the autonomous vehicle.

The communication unit 1200 may receive road information from peripheral devices of the autonomous vehicle. Specifically, the communication unit 1200 may collect information from nearby autonomous vehicles, and may receive road information from unexpected situation detectors, signal controllers, crosswalk signal transmission boards, road weather information systems, positioning correction reference stations, portable dangerous section notification devices, digital display boards, safety facilities, autonomous vehicle maintenance zones, autonomous vehicle mobile stations, radar VDSs, LTE radios, and the like. For example, the communication unit 1200 may receive information about an unexpected situation occurring on the road, such as a vehicle stopped on the road, a pedestrian, or a fallen object, from a nearby autonomous vehicle.

The communication unit 1200 may collect context information by crawling an open application programming interface (API). Specifically, the communication unit 1200 may collect context information by crawling open APIs of the Road Traffic Authority, the Korea Meteorological Administration, the National Police Agency, the Traffic Information Center, and the like. For example, the communication unit 1200 may collect weather information by crawling the Korea Meteorological Administration's website.

The communication unit 1200 may transmit road traffic information to the autonomous vehicle according to the command of the control unit 1300.

The control unit 1300 may be implemented as an application processor (AP), a central processing unit (CPU), a microcontroller unit (MCU), or a similar device depending on hardware, software, or a combination thereof. In this case, the control unit 1300 may be provided in the form of an electronic circuit that processes an electrical signal and performs a control function in hardware, and may be provided in the form of a program or code that drives a hardware circuit in software.

The control unit 1300 may collect road traffic information using data collected through the road traffic information collection unit, determine required information, and transmit the required information to a server or an autonomous vehicle. As needed, the control unit 1300 may determine a road traffic condition based on the information of the road on which the road traffic information providing apparatus 1000 is installed and the road traffic information, and provide the determined road traffic condition to an autonomous vehicle or server within a preset range. More specifically, the control unit 1300 may determine a road traffic condition and transmit required information to an autonomous vehicle based on the determined situation. According to one embodiment, when an unexpected situation occurs on the road, the control unit 1300 may transmit information about the unexpected situation to an autonomous vehicle. According to another embodiment, when the road condition changes (traffic congestion is resolved or traffic congestion occurs), the control unit 1300 may transmit information about the changed road condition to an autonomous vehicle within a preset range, and to a server.

The moving unit 1400 is a device for moving the road traffic information providing apparatus 1000. As needed, the moving unit 1400 may be a vehicle.

The display unit 1500 is configured to display various types of information generated through the road traffic information providing apparatus 1000. As needed, the display unit 1500 may be a digital display board.

Referring to FIG. 1, the server 2000 is connected to one or more road traffic information providing apparatuses 1000 through a wired or wireless communication network.

The server 2000 stores various types of road traffic information. As needed, the server 2000 may collect context information by crawling the open API. When the road traffic information providing apparatus 1000 is connected to the server 2000, the server 2000 may obtain location information of the road traffic information providing apparatus 1000 and provide road traffic information on a road within a preset range based on the location information. As needed, the server may obtain location information of the road traffic information providing apparatus 1000 and transmit weather information of the location in which the road traffic information providing apparatus 1000 is installed based on the location information.

The server 2000 is configured to obtain road traffic information from one or more mobile road traffic information providing apparatuses and predict road traffic information based on the obtained road traffic information.

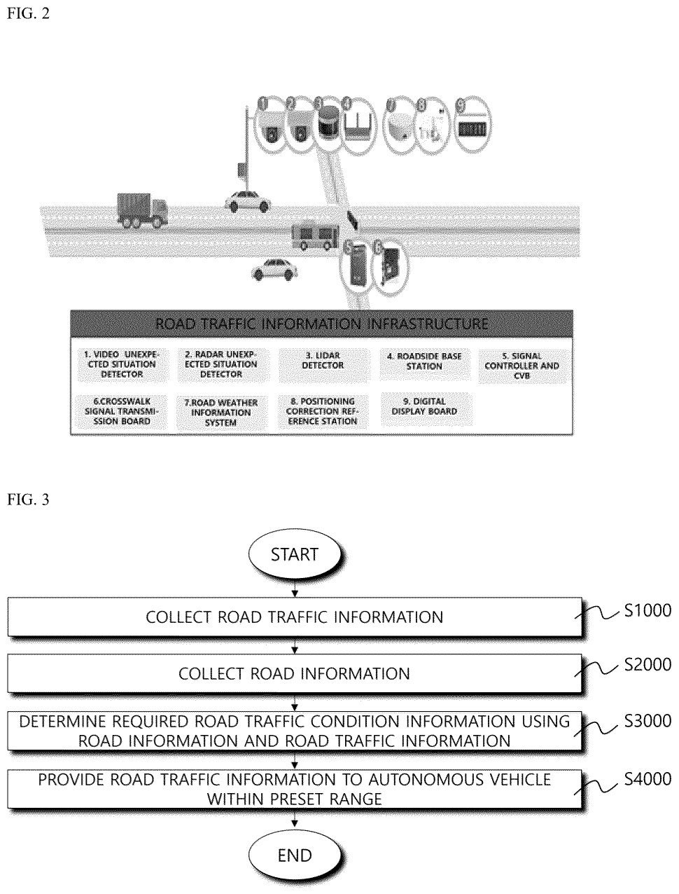

FIG. 2 is a diagram illustrating a configuration for collecting road traffic information using a mobile road traffic information providing system according to one embodiment of the present application. FIG. 3 is a diagram for describing a mobile road traffic information providing method according to one embodiment of the present application. Hereinafter, the present invention will be described in more detail with reference to FIGS. 2 and 3.

The operations in FIG. 3 are not limited in order, and other operations may be performed between two adjacent operations. In addition, at least some of the operations in FIG. 3 may be omitted. In the present invention, when the road traffic information providing apparatus 1000 is referred to as performing a specific operation, it may mean that the control unit 1300 of the road traffic information providing apparatus 1000 performs the specific operation, or that the control unit 1300 controls other hardware to perform the specific operation.

Referring to FIG. 3, the road traffic information providing apparatus 1000 may collect road traffic information (S1000). Specifically, the road traffic information providing apparatus 1000 may collect road traffic information through the sensor unit of the road traffic information collection unit 1100. The sensor unit may include various sensors, and may collect information related to road traffic directly from the outside or collect information related to road traffic through communication from an external server. More specifically, the sensor unit may include at least one sensor from a group including a camera, an ultrasonic sensor, the GPS, a radar, and a LiDAR.

As needed, the road traffic information providing apparatus 1000 may collect road traffic information from a server, an external device, or an autonomous vehicle (S2000). The external device may be an RSU, a signal controller, a traffic signal controller option board (a connected vehicle interface board: CVIB), a crosswalk signal transmission board, a road weather information system, a positioning correction reference station, a portable dangerous section notification device, a digital display board, an autonomous driving sensor recognition device, safety facilities, an autonomous vehicle maintenance zone, an autonomous driving mobile station, a radar VDS, an LTE radio, and the like.

The road traffic information providing apparatus 1000 may collect weather information or road traffic information by crawling an open API. Specifically, the road traffic information providing apparatus 1000 may collect context information by crawling the open API of the Road Traffic Authority, the Korea Meteorological Administration, the National Police Agency, the Traffic Information Center, and the like. For example, the road traffic information providing apparatus 1000 may identify a location through the GPS at a location at which a mobile road traffic information providing apparatus is installed, and collect weather information by crawling the Korea Meteorological Administration webpage in real time.

Since the road traffic information providing apparatus 1000 is formed in a type of mobile, the road traffic information providing apparatus 1000 may collect road information at a location at which the road traffic information providing apparatus 1000 is installed in a mobile manner. The road information may be road information obtained from a server based on a GPS at the location at which the road traffic information providing apparatus 1000 is installed, or may be road information obtained through the sensor unit of the road traffic information providing apparatus 1000.

The road traffic information providing apparatus 1000 may determine required road traffic condition information using the road information and the road traffic information (S3000). Specifically, the road traffic information providing apparatus 1000 determines information required for autonomous vehicles based on the road information and the road traffic information.

The road traffic information providing apparatus 1000 may provide road traffic information to autonomous vehicle within preset range (S4000).

By using the mobile road traffic information providing system according to the present invention, the insufficient autonomous driving traffic infrastructure may be supplemented. In other words, by installing the mobile road traffic information providing system in an area in which a specific event occurs, autonomous vehicles may receive real-time road traffic information, enabling safer autonomous driving.

Features, structures, effects, etc. described in the above embodiments are included in at least one embodiment of the present invention, and are not limited to only one embodiment. Furthermore, features, structures, effects, etc. illustrated in each embodiment may be combined or modified for other embodiments by those skilled in the art to which the embodiments belong. Accordingly, the content related to such combinations and modifications should be interpreted as being included in the scope of the present invention.

As is apparent from the above, insufficient infrastructure for autonomous vehicles can be supplemented using a mobile road traffic information providing system.

Although the present invention has been described with reference to embodiments, it should be understood by those skilled in the art that the embodiments disclosed above should be not considered as limiting the present invention and various modifications and applications that are not illustrated above are possible without departing from the essential characteristics of the present embodiments. That is, each component specifically shown in the embodiment may be implemented with modifications. Differences related to such modifications and applications should be understood as being included in the scope of the present invention defined in the appended claims.

What is claimed is:

1. A mobile road traffic information providing apparatus for autonomous vehicles, comprising:
a road traffic information collection unit that is movably installed on one side of a road and collects road traffic information;
a communication unit that performs communication with an autonomous vehicle or a server; and
a control unit that determines a road traffic condition based on information about a road on which the road traffic information providing apparatus is installed and the road traffic information, and provides the road traffic condition to the autonomous vehicle within a preset range or the server,
wherein the road traffic information collection unit includes:
a traffic light information collection unit that collects signal information of traffic lights within a preset range; and
an unexpected situation detection unit that collects unexpected situation information on a road within a preset range.

2. The mobile road traffic information providing apparatus of claim 1, wherein the road traffic information collection unit further includes a weather information collection unit that collects weather information from the server based on information about a location in which the road traffic information providing apparatus is installed.

3. The mobile road traffic information providing apparatus of claim 1, wherein the mobile road traffic information providing apparatus provides the road traffic information to the autonomous vehicle within the preset range.

4. The mobile road traffic information providing apparatus of claim 1, wherein the road traffic information collection unit collects the road traffic information from the autonomous vehicle within the preset range.

5. The mobile road traffic information providing apparatus of claim 1, wherein the road traffic information collection unit detects an unexpected situation within the preset range using at least one selected from a group including a camera, a radar, and a light detection and ranging (LiDAR).

6. The mobile road traffic information providing apparatus of claim 1, further comprising a moving unit that moves the road traffic information providing apparatus;

7. The mobile road traffic information providing apparatus of claim 1, further comprising a display unit that displays the collected road traffic information.

8. A mobile road traffic information providing system comprising:
a mobile road traffic information providing apparatus that is movably installed on one side of a road and collects road traffic information in a preset range, and determines a road traffic condition based on the road traffic information;
a server that obtains road traffic information from the mobile road traffic information providing apparatuses and predicts road traffic information based on the obtained road traffic information; and
an autonomous vehicle that obtains the road traffic information from the mobile road traffic information providing apparatus,
wherein the mobile road traffic information providing apparatus includes:
a traffic light information collection unit that collects signal information of traffic lights within the preset range; and
an unexpected situation detection unit that collects unexpected situation information on a road within the preset range.

9. The mobile road traffic information providing system of claim 8, wherein the mobile road traffic information providing apparatus provides the road traffic information to the autonomous vehicle within the preset range.
